(19) United States
(12) Patent Application Publication
(10) Pub. No.: US 2023/0177950 A1
(43) Pub. Date: Jun. 8, 2023

(54) VEHICLE INFORMATION PROCESSING SYSTEM, VEHICLE INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Hiroshi UENO, Toyota-shi (JP); Yoshihisa YAMADA, Nagoya-shi (JP)

(73) Assignee: TOYOTA JIDOSHA KABUSHIKI KAISHA, Toyota-shi (JP)

(21) Appl. No.: 17/979,882

(22) Filed: Nov. 3, 2022

(30) Foreign Application Priority Data
Dec. 3, 2021 (JP) 2021-196840

(51) Int. Cl. G08G 1/01; B60W 30/14

(52) U.S. Cl. CPC G08G 1/0112; G08G 1/0125; B60W 30/143; B60W 2520/28; B60W 2756/10; B60W 2555/00

(57) ABSTRACT

A vehicle information processing system includes a vehicle information processing device including one or more processors. The one or more processors are configured to receive input information including information on a wheel velocity of a vehicle, and calculate a velocity of the vehicle traveling on an expressway as a feature by using the input information. The input information is information that is received during a period in which a predetermined condition is satisfied out of a period in which the one or more processors receive the input information. The predetermined condition indicates that the vehicle is traveling on the expressway.

### CROSS-REFERENCE TO RELATED APPLICATION

This application claims priority to Japanese Patent Application No. 2021-196840 filed on Dec. 3, 2021, incorporated herein by reference in its entirety.

### BACKGROUND

### 1. Technical Field

The present disclosure relates to a technique for estimating the congestion state of an expressway using information obtained from a vehicle.

### 2. Description of Related Art

There is a technique of predicting required travel time of a vehicle from an entrance tollgate to an exit tollgate installed on an expressway etc. by using data on the time the vehicle passed through the entrance tollgate of the expressway and data on the time the vehicle passed through the exit tollgate of the expressway. For example, Japanese Unexamined Patent Application Publication No. 2002-298282 (JP 2002-298282 A) discloses a technology in which a required-travel-time pattern obtained by calculating actual values of the required travel time using passage time data for an entrance tollgate and an exit tollgate is stored every day and the required travel time is predicted from the required-travel-time pattern of the prediction day based on the traffic conditions of the prediction day.

### SUMMARY

However, the required travel time on an expressway etc. may not be able to be accurately estimated because the required travel time varies greatly depending on the congestion state etc. of a road. Therefore, the required travel time may not be able to be accurately estimated from the data on the passage times of entrance and exit tollgates as described in JP 2002-298282 A.

The present disclosure provides a vehicle information processing system, vehicle information processing method, and non-transitory storage medium capable of accurately estimating required travel time of a vehicle.

A first aspect of the present disclosure is a vehicle information processing system. The vehicle information processing system includes a vehicle information processing device including one or more processors. The one or more processors are configured to receive input information including information on a wheel velocity of a vehicle, and calculate a velocity of the vehicle traveling on an expressway as a feature by using the input information. The input information is information that is received during a period in which a predetermined condition is satisfied out of a period in which the one or more processors receive the input information. The predetermined condition indicates that the vehicle is traveling on the expressway.

According to the first aspect, the velocity of the vehicle traveling on the expressway is calculated as a feature. Therefore, for example, the congestion state of the expressway can be estimated by using the feature. A required travel time can therefore be accurately predicted according to the congestion state.

In the first aspect, the input information may include information on wheel velocities of right and left wheels of the vehicle. The predetermined condition may include a condition that a traveling state continues for a predetermined time or more. The traveling state may be a state in which the velocity of the vehicle is higher than a first threshold value and a magnitude of a difference between the wheel velocities of the right and left wheels is smaller than a second threshold value.

According to the above configuration, whether the vehicle is traveling on an expressway can be accurately determined using the wheel velocities of the right and left wheels of the vehicle.

In the first aspect, the one or more processors may be configured to generate a congestion level indicating a degree of congestion of the expressway by using a distribution of a plurality of the features calculated during the period in which the predetermined condition is satisfied.

According to the above configuration, the congestion level indicating the congestion state of the expressway can be accurately estimated by using the distribution of the features while the vehicle is traveling on the expressway. Moreover, information that is valuable to users, such as the congestion state of the expressway, can be generated by performing concealment (e.g., statistic quantification) so that individuals cannot be identified.

In the first aspect, the one or more processors may be configured to calculate a standard deviation of the velocity of the vehicle calculated a plurality of times during the period in which the predetermined condition is satisfied, and set the congestion level to a value indicating that the expressway is congested, when the standard deviation is larger than a threshold value.

According to the above configuration, the congestion state of the expressway can be accurately estimated by using the standard deviation of the velocity of the vehicle.

In the first aspect, the one or more processors are configured to set the congestion level to a value indicating that the expressway is congested, when a rate is smaller than a threshold value during the period in which the predetermined condition is satisfied. The rate may be a rate at which the velocity of the vehicle under cruise control achieves a target velocity set in the cruise control.

According to the above configuration, the congestion state of the expressway can be accurately estimated by using the rate at which the velocity of the vehicle achieves the target velocity.

In the first aspect, the one or more processors may be configured to transmit information on the congestion level to outside of the vehicle.

According to the above configuration, since the vehicle can transmit the information on the congestion level of the expressway to the outside of the vehicle, the utility value of the information on the congestion level of the expressway can be increased.

In the first aspect, the vehicle information processing system may further include a prediction device. The prediction device may be configured to predict a required travel time in a predetermined section in which the vehicle travels on the expressway by using information from a plurality of the vehicles equipped with the vehicle information processing device, and predict the required travel time from a proportion of the vehicles with a predetermined congestion level in the vehicles.

According to the above configuration, the required travel time in the section in which the vehicle travels on the expressway can be accurately predicted by using information on the congestion level from the plurality of vehicles.

A second aspect of the present disclosure is a vehicle information processing method. The vehicle information processing method includes: receiving input information including information on a wheel velocity of a vehicle; and calculating a velocity of the vehicle traveling on an expressway as a feature by using the input information. The input information is information that is received during a period in which a predetermined condition is satisfied out of a period in which the input information is received. The predetermined condition indicates that the vehicle is traveling on the expressway.

A third aspect of the present disclosure is a non-transitory storage medium storing instructions that are executable by one or more processors in a computer and that cause the one or more processors to perform functions. The functions include: receiving input information including information on a wheel velocity of a vehicle; and calculating a velocity of the vehicle traveling on an expressway as a feature by using the input information. The input information is information that is received during a period in which a predetermined condition is satisfied out of a period in which the input information is received. The predetermined condition indicates that the vehicle is traveling on the expressway.

According to the second aspect, the velocity of the vehicle traveling on the expressway is calculated as a feature. Therefore, for example, the congestion state of the expressway can be estimated by using the feature. A required travel time can therefore be accurately predicted according to the congestion state.

According to the third aspect, the velocity of the vehicle traveling on the expressway is calculated as a feature. Therefore, for example, the congestion state of the expressway can be estimated by using the feature. A required travel time can therefore be accurately predicted according to the congestion state.

According to the first, second, and third aspects of the present disclosure, the vehicle information processing system, vehicle information processing method, and non-transitory storage medium capable of accurately estimating the required travel time of a vehicle can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an example of a configuration of a vehicle information management system;

FIG. 2 illustrates a configuration of an example of a vehicle information processing device according to an embodiment;

FIG. 3 illustrates an example of a process that is performed by a second processing unit in the embodiment;

FIG. 4 illustrates an example of a process that is performed by a third processing unit in the embodiment;

FIG. 5 is a graph showing an example of a distribution of the vehicle body velocity when a vehicle travels on an uncongested expressway;

FIG. 6 is a graph showing an example of a distribution of the vehicle body velocity when a vehicle travels on a congested expressway;

FIG. 7 is a graph showing an example of a change in required travel time with respect to time in a predetermined section;

FIG. 8 is a flowchart showing an example of a process that is performed by a second processing unit of a brake electronic control unit (ECU);

FIG. 9 is a flowchart showing an example of a process that is performed by a third processing unit of the brake ECU;

FIG. 10 is a flowchart showing an example of a process that is performed by a data center; and

FIG. 11 is a flowchart showing an example of a process that is performed by the third processing unit of the brake ECU in a modification.

### DETAILED DESCRIPTION OF EMBODIMENTS

Hereinafter, an embodiment of the present disclosure will be described in detail with reference to the drawings. The same or corresponding parts are denoted by the same reference signs throughout the drawings, and description thereof will not be repeated.

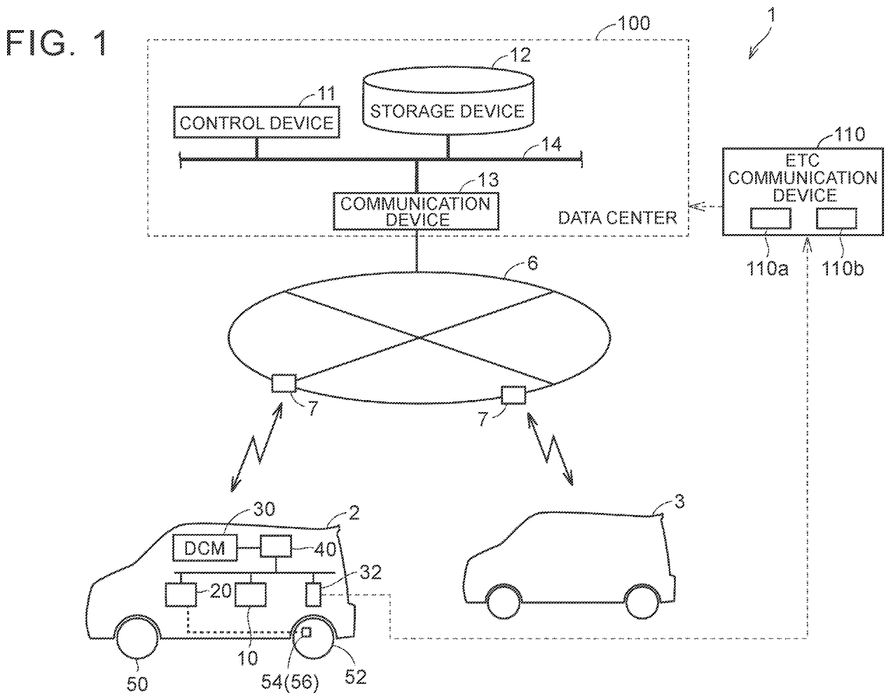

FIG. 1 illustrates an example of a configuration of a vehicle information management system 1. As shown in FIG. 1, in the present embodiment, the vehicle information management system 1 includes a plurality of vehicles 2, 3, a communication network 6, base stations 7, a data center 100, and an electronic toll collection system (ETC) communication device 110.

The vehicles 2, 3 may be any vehicles capable of communicating with the data center 100. For example, the vehicles 2, 3 may be vehicles using an engine as a driving source, battery electric vehicles using an electric motor as a driving source, or hybrid electric vehicles including an engine and an electric motor and using either or both of the engine and the electric motor as a driving source. Although FIG. 1 shows only two vehicles 2, 3 for convenience of explanation, the number of vehicles is not particularly limited to two, and may be three or more.

The vehicle information management system 1 is configured to acquire predetermined information from the vehicles 2, 3 configured to communicate with the data center 100, and manage the acquired information.

The data center 100 includes a control device 11, a storage device 12, and a communication device 13. The control device 11, the storage device 12, and the communication device 13 are connected to each other via a communication bus 14 so that these devices 11, 12, and 13 can communicate with each other.

Although not shown in the figure, the control device 11 includes a central processing unit (CPU), a memory such as a read-only memory (ROM) and a random access memory (RAM), and an input and output port for inputting and outputting various signals. Various controls that are performed by the control device 11 are performed by software processing, that is, by the CPU reading a program stored in the memory. The various controls that are performed by the control device 11 can also be implemented by a general-purpose server (not shown) executing a program stored in a storage medium. However, the various controls that are performed by the control device 11 need not necessarily be performed by the software processing, and may be performed by processing with dedicated hardware (electronic circuit).

The storage device 12 stores predetermined information on the vehicles 2, 3 configured to communicate with the data center 100. The predetermined information includes, for example, information on a feature of each vehicle 2, 3 that will be described later, and information identifying each vehicle 2, 3 (hereinafter referred to as vehicle identification (ID)). The vehicle ID is unique information set for each vehicle. The data center 100 can identify a sender vehicle by the vehicle ID.

The communication device 13 implements bidirectional communication between the control device 11 and the communication network 6. The data center 100 can communicate with a plurality of vehicles including the vehicles 2, 3 via the base stations 7 on the communication network 6 by using the communication device 13.

The ETC communication device 110 includes, for example, communication devices installed at an entrance and exit of an expressway (including, for example, a toll road such as a turnpike). More specifically, the ETC communication device 110 includes, for example, a communication device provided at a tollgate installed at an interchange or junction connecting an expressway and a local road or another expressway.

The ETC communication device 110 includes, for example, a first communication device 110a installed on the road at an entrance of an expressway, and a second communication device 110b installed on the road at an exit of the expressway. The expressway has a plurality of entrances and exits at its starting point, ending point, and intermediate points. The first communication device 110a and the second communication device 110b are installed on the road at each of the entrances and exits. FIG. 1 shows, as an example, the first communication device 110a installed on the road the vehicle 2 passes through when entering an expressway, and a second communication device 110b installed on the road the vehicle 2 passes through when leaving the expressway. The ETC communication device 110 is configured to communicate with the data center 100 via the communication network 6. The ETC communication device 110 may be configured to communicate with the data center 100 via a network different from the communication network 6.

When the vehicle 2 passes through the road where the first communication device 110a is installed, the first communication device 110a establishes communication with an ETC in-vehicle unit 32 of the vehicle 2, acquires payment information of an ETC card that is necessary to pay a toll and information that can identify the vehicle 2 (e.g., an in-vehicle unit identification (ID) or a vehicle ID) from the ETC in-vehicle unit 32, and transmits the time the vehicle 2 passed through the road (entrance passage time) Tin and information that can identify the position of the first communication device 110a (e.g., a tollgate number etc., hereinafter also referred to as “entrance tollgate information”) to the ETC in-vehicle unit 32.

When the vehicle 2 passes through the road where the second communication device 110b is installed, the second communication device 110b establishes communication with the ETC in-vehicle unit 32 of the vehicle 2, acquires the payment information, the information that can identify the vehicle 2, the entrance passage time Tin, and the entrance tollgate information from the ETC in-vehicle unit 32, and transmits the time the vehicle 2 passed through the road (exit passage time) Tout, information that can identify the position of the second communication device 110b (e.g., a tollgate number etc., hereinafter also referred to as “exit tollgate information”), and information on a toll etc. to the ETC in-vehicle unit 32 and the data center 100.

The information the first communication device 110a and the second communication device 110b acquire from the ETC in-vehicle unit 32 is not particularly limited to the above information. The information the ETC communication device 110 transmits to the data center 100 is also not particularly limited to the above information. An example in which the data center 100 also carries out ETC card transactions is described in the present embodiment. However, a server for carrying out ETC card transactions may be set separately from the data center 100.

Next, a specific configuration of the vehicles 2, 3 will be described. Since the vehicles 2, 3 basically have the same configuration, the configuration of the vehicle 2 will be representatively described below.

The vehicle 2 includes drive wheels 50 and driven wheels 52. When the drive wheel 50 is rotated by the operation of the driving source, a driving force acts on the vehicle 2 and the vehicle 2 moves accordingly.

The vehicle 2 further includes an advanced driver assistance system-electronic control unit (ADAS-ECU) 10, a brake ECU 20, a Data Communication Module (DCM) 30, and a central ECU 40.

The ADAS-ECU 10, the brake ECU 20, and the central ECU 40 are all computers including a processor that execute a program, such as a CPU, a memory, and an input and output interface.

The ADAS-ECU 10 includes a driver assistance system having functions related to driver assistance of the vehicle 2. The driver assistance system is configured to implement various functions to assist in driving of the vehicle 2 including at least one of the following three controls of the vehicle 2 by running an application installed on the driver assistance system: steering control, drive control, and braking control. Examples of the application installed on the driver assistance system include an application that implements functions of an autonomous driving (AD) system, an application that implements functions of an automated parking system, and an application that implements functions of an advanced driver assistance system (ADAS) (hereinafter referred to as the “ADAS application”).

For example, the ADAS application includes at least one of the following applications: an application that implements functions of vehicle following driving (adaptive cruise control (ACC) etc.) for maintaining a constant distance to a vehicle ahead, an application that implements functions of an auto speed limiter (ASL) for perceiving a velocity limit and adapting the maximum velocity of the vehicle 2 to the velocity limit, an application that implements functions of lane keeping assistance (lane keeping assist (LKA), lane tracing assist (LTA), etc.) for keeping the vehicle 2 within its lane, an application that implements functions of collision damage reduction braking (autonomous emergency braking (AEB), pre-crash safety (PCS), etc.) for automatically braking the vehicle 2 in order to reduce damage from a collision, and an application that implements functions of lane deviation warning (lane departure warning (LDW), lane departure alert (LDA), etc.) for alerting a driver of the vehicle 2 that the vehicle 2 is deviating from its lane.

Each application on the driver assistance system outputs requests of a kinematic plan that guarantees merchantability (functionality) of the application alone to the brake ECU 20, based on, for example, information on vehicle surroundings acquired (input) from a plurality of sensors, not shown, and an assistance request from the driver. Examples of the sensors include a vision sensor such as a forward-facing camera, a radar, a light detection and ranging (LiDAR) sensor, and a position detection device.

Each application acquires, as perceived sensor information, information on vehicle surroundings obtained by integrating detection results from one or more sensors, and also acquires an assistance request from the driver via a user interface (not shown) such as a switch. For example, each application can perceive other vehicles, obstacles, or persons around the vehicle 2 by processing, using artificial intelligence (AI) or an image processor, images or videos of vehicle surroundings acquired by the sensors.

The kinematic plan includes, for example, a request related to longitudinal acceleration or deceleration to be generated in the vehicle 2, a request related to the steering angle of the vehicle 2, and a request related to brake holding of the vehicle 2.

The brake ECU 20 controls a brake actuator that generates a braking force in the vehicle 2 by using the detection results from the sensors. The brake ECU 20 also sets a motion request for the vehicle 2 that fulfills the requests of the kinematic plan from the ADAS-ECU 10. The motion request for the vehicle 2 set by the brake ECU 20 is fulfilled by an actuator system (not shown) mounted on the vehicle 2. The actuator system includes, for example, a plurality of types of actuator system such as a power train system, a brake system, and a steering system.

For example, a first wheel velocity sensor 54 and a second wheel velocity sensor 56 are connected to the brake ECU 20.

The first wheel velocity sensor 54 detects the rotational velocity (wheel velocity) Vl of one of the two driven wheels 52 (e.g., the left driven wheel 52). The first wheel velocity sensor 54 transmits a signal indicating the detected rotational velocity Vl of the left driven wheel 52 to the brake ECU 20.

The second wheel velocity sensor 56 detects the rotational velocity Vr of the other driven wheel 52 (e.g., the right driven wheel 52). The second wheel velocity sensor 56 transmits a signal indicating the detected rotational velocity Vr of the right driven wheel 52 to the brake ECU 20.

The configuration in which the first wheel velocity sensor 54 and the second wheel velocity sensor 56 are connected to the brake ECU 20 and directly transmit the detection results to the brake ECU 20 is illustrated as an example in FIG. 1. However, any of the sensors may be connected to other ECU, and the detection results of that sensor may be input to the brake ECU 20 via a communication bus or the central ECU 40.

For example, the brake ECU 20 receives information on the running state of various applications, receives information on the steering angle, the depression amount of an accelerator pedal or brake pedal, or other driving operations such as a shift range, and receives information on the behavior of the vehicle 2, in addition to the information on the kinematic plan from the ADAS-ECU 10.

The DCM 30 is a communication module configured to bidirectionally communicate with the data center 100.

The central ECU 40 is configured to communicate with, for example, the brake ECU 20, and is also configured to communicate with the data center 100 using the DCM 30. For example, the central ECU 40 transmits information received from the brake ECU 20 to the data center 100 via the DCM 30.

In the present embodiment, the central ECU 40 is described as an ECU that transmits information received from the brake ECU 20 to the data center 100 via the DCM 30. However, for example, the central ECU 40 may be an ECU having a function to relay communication between various ECUs (gateway function), or may be an ECU that includes a memory (not shown) whose stored content can be updated using update information received from the data center 100, and from which predetermined information including update information stored from various ECUs to the memory upon starting of the system of the vehicle 2 is read.

The vehicle 2 further includes the ETC in-vehicle unit 32. The ETC in-vehicle unit 32 is configured to communicate with the first communication device 110a and the second communication device 110b of the above ETC communication device 110. Since the information received and transmitted during communication is as described above, detailed description thereof will not be repeated. The ETC in-vehicle unit 32 is configured to communicate with other ECUs via a communication bus. Therefore, the ETC in-vehicle unit 32 is configured to transmit information acquired from the ETC communication device 110 to other ECUs.

When the vehicle 2 having the above configuration travels on, for example, a section of an expressway from an entrance near the place of departure to an exit near the destination, it is desired to accurately predict the required travel time of the vehicle. However, in the case where, for example, the time calculated using the entrance passage time and the exit passage time is calculated as the required travel time, the required travel time may not be able to be accurately estimated because the required travel time varies greatly depending on the congestion state etc. of the road.

In the present embodiment, the brake ECU 20 receives input information including information on the wheel velocities of the vehicle 2. The brake ECU 20 calculates the velocity of the vehicle 2 traveling on an expressway as a feature by using the input information received during a period in which a predetermined condition indicating that the vehicle 2 is traveling on an expressway is satisfied out of a period in which the brake ECU 20 receives the input information. The predetermined condition includes a condition that a traveling state in which the vehicle body velocity is higher than a first threshold value and the magnitude of the difference between the right and left wheel velocities is smaller than a second threshold value continues for a predetermined time or more.

In this case, since the velocity of the vehicle 2 traveling on an expressway is calculated as a feature, the congestion state of the expressway can be estimated by using the feature as described later. The required travel time can therefore be accurately predicted according to the congestion state.

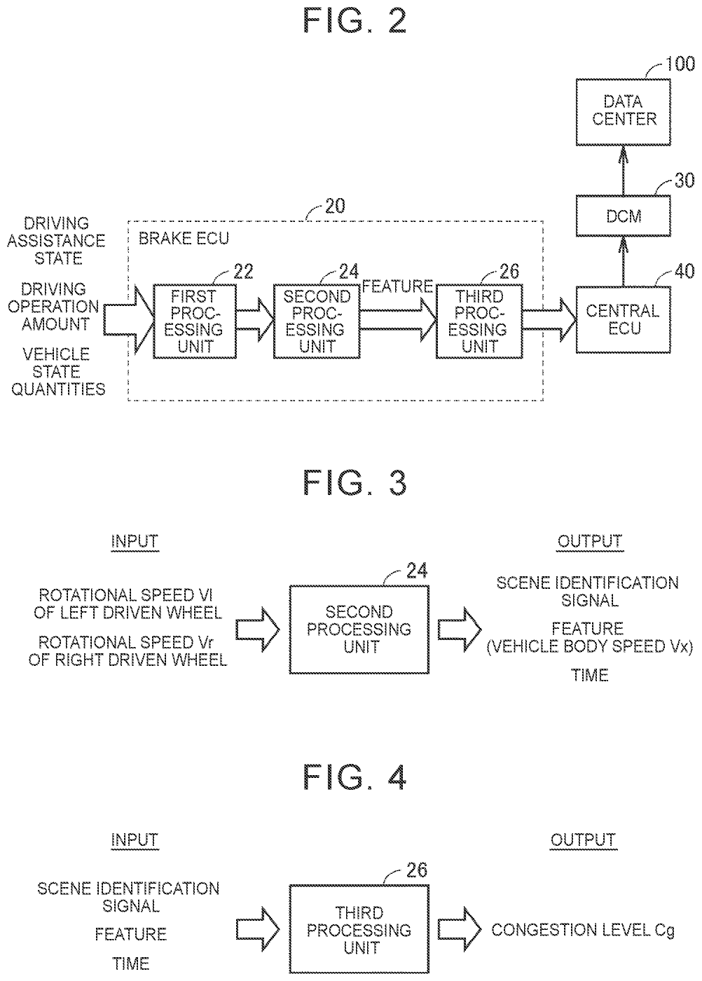

FIG. 2 illustrates a configuration of an example of a vehicle information processing device according to the present embodiment. The vehicle information processing device according to the present embodiment is implemented by the brake ECU 20. As shown in FIG. 2, the brake ECU 20 includes a first processing unit 22, a second processing unit 24, and a third processing unit 26.

The first processing unit 22 receives, for example, information on the driver assistance state indicating the operating state of the driver assistance system, information on the driving operation amount of a steering wheel, the accelerator pedal, the brake pedal, etc., and information on vehicle state quantities indicating the detection results from various sensors. Of the received information, the first processing unit 22 outputs the rotational velocity Vl of the left driven wheel 52 detected by the first wheel velocity sensor 54 and the rotational velocity Vr of the right driven wheel 52 detected by the second wheel velocity sensor 56 to the second processing unit 24.

The second processing unit 24 calculates the velocity (vehicle body velocity) Vx of the vehicle 2 as a feature by using the input information received during the period in which the predetermined condition is satisfied out of the period in which the first processing unit 22 receives the input information.

FIG. 3 illustrates an example of a process that is performed by the second processing unit 24 in the present embodiment. As shown in FIG. 3, the rotational velocity Vl of the left driven wheel 52 detected by the first wheel velocity sensor 54 and the rotational velocity Vr of the right driven wheel 52 detected by the second wheel velocity sensor 56 are input as input information from the first processing unit 22 to the second processing unit 24.

The second processing unit 24 determines whether the predetermined condition is satisfied by using the input information.

Specifically, the second processing unit 24 calculates the vehicle body velocity Vx by using the input information. The second processing unit 24 calculates the vehicle body velocity Vx by using, for example, the average value (=(Vr+Vl)/2) of the rotational velocities Vr, Vl and information such as the tire diameter. The second processing unit 24 calculates the magnitude Vd (=|Vr−Vl|) of the difference between the rotational velocities Vr, Vl of the right and left driven wheels 52 by using the input information.

The predetermined condition includes a condition indicating that the vehicle 2 is traveling on a main lane of an expressway. Specifically, the predetermined condition includes a condition that the traveling state in which the vehicle body velocity Vx is higher than the first threshold value (e.g., 40 km/h) and the magnitude Vd (=|Vr−Vl|) of the difference between the rotational velocities Vr, Vl of the right and left driven wheels 52 is smaller than the second threshold value (e.g., a value equivalent to 3 km/h) continues for the predetermined time (e.g., about 15 minutes). The first threshold value is set based on the velocity limit, the number of lanes, etc. of the expressway. The first threshold value is, for example, a predetermined value adapted by experiments etc. The second threshold value is set based on, for example, the number of lanes etc. of the expressway. The second threshold value is set by being adapted by experiments etc. so that the range of velocity difference caused by a lane change etc. is included and the range of velocity difference caused by a steep turn is excluded. The second threshold value is set so that, for example, the angular velocity of the vehicle 2 in the yaw direction (turning direction) is equal to or less than a threshold value (e.g., 30 deg/sec etc.).

The second processing unit 24 sets a flag when the second processing unit 24 determines that the predetermined condition is satisfied (hereinafter this flag will be referred to as “expressway traveling flag Fj”). The second processing unit 24 clears the expressway traveling flag Fj when the second processing unit 24 determines that the predetermined condition is not satisfied. The second processing unit 24 outputs a signal indicating the state of the expressway traveling flag Fj as a scene identification signal to the third processing unit 26. The second processing unit 24 outputs, together with the scene identification signal, the vehicle body velocity Vx as a feature to the third processing unit 26.

By using the feature, the third processing unit 26 outputs information indicating whether the expressway on which the vehicle 2 travels is congested to the central ECU 40. More specifically, the third processing unit 26 sets, by using the information output from the second processing unit 24, a value indicating the degree of congestion of the expressway on which the vehicle 2 travels (hereinafter this value will be referred to as “congestion level Cg”). For example, the third processing unit 26 sets the congestion level Cg by using the information output from the second processing unit 24 when the expressway traveling flag Fj included in the scene identification signal is ON.

FIG. 4 illustrates an example of a process that is performed by the third processing unit 26 in the present embodiment. As shown in FIG. 4, information indicating the scene identification signal, the feature, and the time is input from the second processing unit 24 to the third processing unit 26. The information input to the third processing unit 26 is stored in, for example, a storage device such as a memory.

The third processing unit 26 calculates a mean value Avx of the vehicle body velocity Vx using a plurality of vehicle body velocities Vx input from the second processing unit 24 during the period in which the predetermined condition is satisfied. The third processing unit 26 also calculates a standard deviation σ of the vehicle body velocity Vx using the vehicle body velocities Vx input from the second processing unit 24 during the period in which the predetermined condition is satisfied. For a method for calculating the mean value Avx and a method for calculating the standard deviation σ, a predetermined technique need only be used, and detailed description thereof will not be given.

The third processing unit 26 sets the congestion level Cg using the calculated standard deviation σ and mean value Avx. For example, when the mean value Avx minus the standard deviation σ (Avx−σ) is lower than the velocity (e.g., 60 km/h) at which the driver of the vehicle traveling on the expressway feels that the expressway is congested (that is, when the relationship of “Avx−σ<60” (km/h) is satisfied), the third processing unit 26 sets the congestion level Cg to a value indicating that the expressway is congested (e.g., 1).

On the other hand, when the above relationship is not satisfied, the third processing unit 26 sets the congestion level Cg to a value indicating that the expressway is not congested (e.g., 2). The third processing unit 26 outputs information on the set congestion level Cg to the central ECU 40. During the period in which the predetermined condition is satisfied, the third processing unit 26 sets the congestion level Cg using the mean value Avx and the standard deviation σ that are calculated every time a predetermined time elapses, and outputs the set congestion level Cg to the central ECU 40.

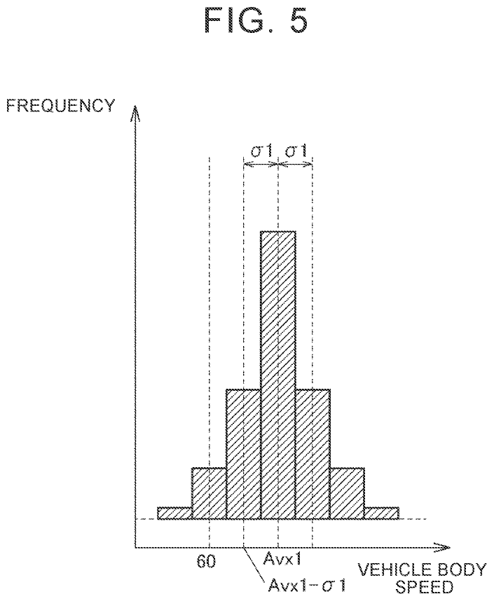

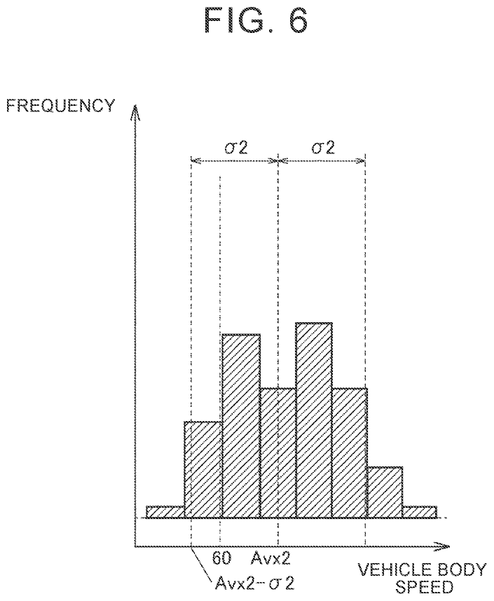

FIG. 5 is a graph showing an example of a distribution of the vehicle body velocity Vx when the vehicle 2 travels on an uncongested expressway. FIG. 6 is a graph showing an example of a distribution of the vehicle body velocity Vx when the vehicle 2 travels on a congested expressway. The ordinate in FIGS. 5 and 6 represents the frequency (count). The abscissa in FIGS. 5 and 6 represents the vehicle body velocity Vx. The distribution graphs of FIGS. 5 and 6 are created by, for example, dividing a velocity range into a plurality of successive sections and repeating the process of determining to which of the sections the acquired vehicle body velocity Vx corresponds and incrementing the frequency of that section by one. For example, as shown in FIG. 5, in the case where a standard deviation σ1 of the vehicle body velocity is calculated in relation to a mean value Avx1 of the vehicle body speed, the congestion level Cg is set to a value indicating that the expressway is not congested, when the relationship that the value of “Avx1−σ1” is higher than 60 km/h (equivalent to the relationship of “σ1<Avx1−60”) is satisfied.

On the other hand, as shown in FIG. 6, in the case where a standard deviation σ2 of the vehicle body velocity is calculated in relation to a mean value Avx2 of the vehicle body speed, the congestion level Cg is set to a value indicating that the expressway is congested, when the relationship that the value of “Avx2−σ2” is equal to or less than 60 km/h (equivalent to the relationship of “σ2≥Avx2−60”) is satisfied.

The central ECU 40 transmits the information input from the third processing unit 26 to the data center 100 via the DCM 30. The central ECU 40 transmits, at a predetermined transmission timing, the most recent value out of the values of the congestion level Cg input from the third processing unit 26 to the data center 100 via the DCM 30.

For example, the third processing unit 26 may acquire the entrance passage time Tin and the entrance tollgate information of the expressway corresponding to the period in which the predetermined condition is satisfied from the ETC in-vehicle unit 32, and output the acquired entrance passage time Tin and entrance tollgate information, together with the above congestion level Cg, to the central ECU 40. Alternatively, for example, when information on the congestion level Cg is input from the third processing unit 26 to the central ECU 40, the central ECU 40 may acquire the entrance passage time Tin and the entrance tollgate information of the expressway corresponding to the period in which the predetermined condition is satisfied from the ETC in-vehicle unit 32, and transmit the acquired information, together with the information input from the third processing unit 26, to the data center 100 via the DCM 30.

When the congestion level Cg, the entrance passage time Tin, and the entrance tollgate information are input from the vehicle 2 to the data center 100 and the exit passage time Tout of the vehicle 2 and the exit tollgate information are input from the ETC communication device 110 to the data center 100, the data center 100 estimates a change in required travel time with respect to time during a congestion period based on actual values, estimates a change in required travel time with respect to time during a normal period (non-congestion period) based on actual values, and estimates a change in required travel time from the entrance tollgate to the exit tollgate through which the vehicle 2 has passed with respect to time at and after the current time by using the input congestion level Cg, entrance passage time Tin, and exit passage time Tout.

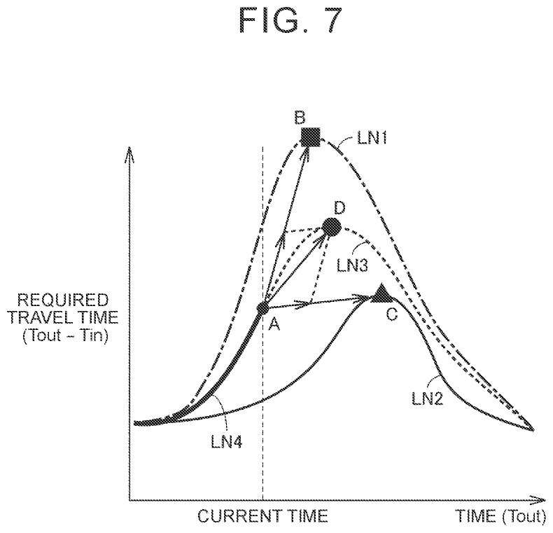

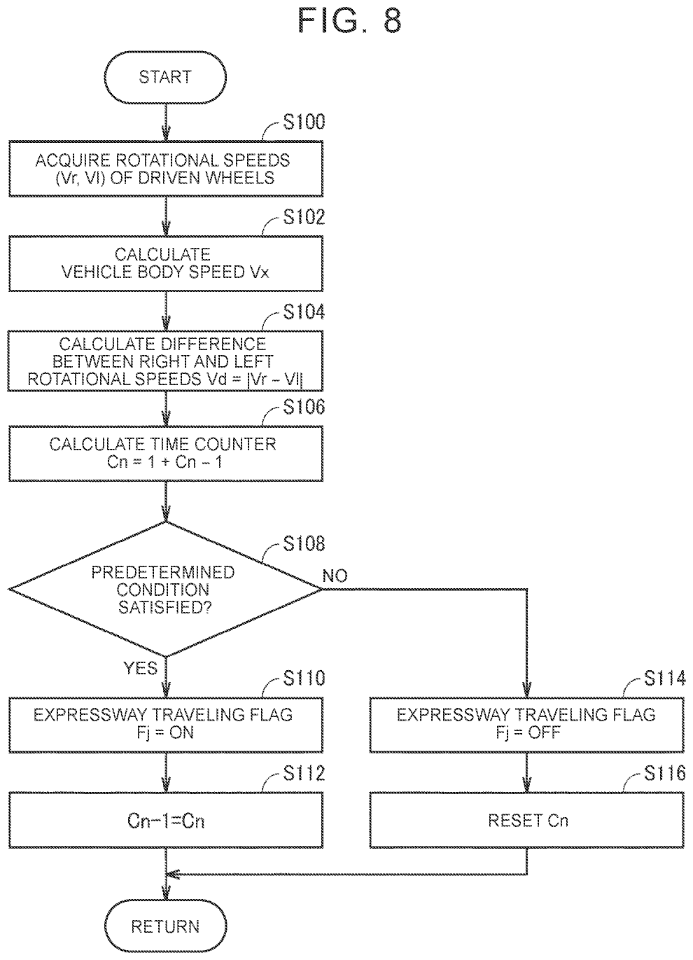

Hereinafter, an example of a method for estimating a change in required travel time with respect to time at and after the current time will be described with reference to FIG. 7. FIG. 7 is a graph showing an example of a change in required travel time with respect to time in a predetermined section (section from the entrance tollgate to the exit tollgate of the expressway through which the vehicle 2 passes).

The abscissa in FIG. 7 represents the exit passage time Tout. The ordinate in FIG. 7 represents a change in required travel time. The required travel time is a value obtained by subtracting the entrance passage time Tin from the exit passage time Tout. LN1 (long dashed short dashed line) in FIG. 7 shows a change in required travel time with respect to time predicted from actual data accumulated in the past during a congestion period. LN2 (thin continuous line) in FIG. 7 shows a change in required travel time with respect to time predicted from actual data accumulated in the past during a normal period. LN3 (dashed line) in FIG. 7 shows a predicted change in required travel time with respect to the current time. LN4 (thick continuous line) in FIG. 7 shows a change in required travel time with respect to time obtained by using the entrance passage times Tin and exit passage times Tout obtained from other vehicles up to the current time.

For example, when the required travel time for the current time based on the entrance passage time Tin and exit passage time Tout received from the vehicle 2 is the time corresponding to the point A, the data center 100 calculates a vector from the point A to the point D (circle in FIG. 7) by using a vector from the point A to the point B (square in FIG. 7) and a vector from the point A to the point C (triangle in FIG. 7). The data center 100 thus estimates a peak value of the required travel time of the day and the time the required travel time will reach the peak value, and predicts such a change as shown by LN3 of FIG. 7 so that the predicted change passes through the estimated peak point.

More specifically, the required travel time at the point B corresponds to a peak value of the required travel time in the change in required travel time with respect to time predicted from actual data accumulated in the past during the congestion period. The travel required time at the point C corresponds to a peak value of the required travel time in the change in required travel time with respect to time predicted from actual data accumulated in the past during the normal period.

The data center 100 sets a coefficient a for a first vector from the point A to the point B and a coefficient b for a second vector from the point A to the point C by using the congestion level Cg. The data center 100 acquires the congestion levels Cg from a plurality of vehicles, including the vehicle 2, that passes through the section from the entrance to the exit of the expressway through which the vehicle 2 has passed during the most recent predetermined period, and calculates a proportion Rcr of the vehicles whose congestion level Cg indicates that the expressway is congested in the plurality of vehicles, and an amount of change dRcr in proportion Rcr per unit time. The data center 100 sets the coefficient a by using a first function f(Rcr, dRcr) that takes the proportion Rcr and the amount of change dRcr as input parameters. The data center 100 also sets the coefficient b by using a second function g(Rcr, dRcr) that takes the proportion Rcr and the amount of change dRcr as input parameters.

The data center 100 identifies the point D by calculating, as the vector from the point A to the point D, the sum of a vector with a length equal to the first vector multiplied by the coefficient a and a vector with a length equal to the second vector multiplied by the coefficient b. The data center 100 sets a curve showing a change in required travel time with respect to time that has a peak value at the point D. The data center 100 may set the curve shown by LN3 of FIG. 7 at and after the current time by, for example, shrinking and moving the curve shown by LN1 of FIG. 7 so that the peak point moves to the point D. Alternatively, the data center 100 may set the curve shown in LN3 of FIG. 7 at and after the current time by, for example, expanding and moving the curve shown in LN2 of FIG. 7 so that the peak point moves to the point D.

Once the curve shown in LN3 of FIG. 7 is set, the data center 100 may release to the public the set curve or the required travel time corresponding to time.

The data center 100 may request the ETC communication device 110 for the exit passage time Tout of the vehicle 2 when, for example, the congestion level Cg, the entrance passage time Tin, and the entrance tollgate information are input from the vehicle 2. In response to the request, the ETC communication device 110 may transmit the exit passage time Tout of the vehicle 2 together with the exit tollgate information to the data center 100 when the ETC communication device 110 acquires the exit passage time Tout. Alternatively, when the vehicle 2 acquires the entrance passage time Tin and the exit passage time Tout from the ETC in-vehicle unit 32 and acquires the most recent value of the congestion level Cg, the vehicle 2 may transmit these pieces of information together with the entrance tollgate information and the exit tollgate information to the data center 100.

Next, an example of a process that is performed by the second processing unit 24 of the brake ECU 20 of the vehicle 2 will be described with reference to FIG. 8. FIG. 8 is a flowchart showing an example of a process that is performed by the second processing unit 24 of the brake ECU 20. A series of steps shown in this flowchart is repeatedly performed by the second processing unit 24 of the brake ECU 20 at predetermined control cycles.

In step (hereinafter referred to as “S”) 100, the brake ECU 20 (specifically, the second processing unit 24) acquires data corresponding to input information. Specifically, the brake ECU 20 acquires data corresponding to input information including, for example, information on the rotational velocity Vr of the right driven wheel 52 and information on the rotational velocity Vl of the left driven wheel 52.

In S102, the brake ECU 20 calculates the vehicle body velocity Vx. Specifically, the brake ECU 20 calculates the vehicle body velocity Vx using the average value of the rotational velocities Vr, Vl. The brake ECU 20 stores, for example, the calculated vehicle body velocity Vx in a memory etc. in association with the value of the expressway traveling flag Fj that will be described later.

In S104, the brake ECU 20 calculates the magnitude Vd (=|Vr−Vl|) of the difference between the rotational velocities Vr, Vl of the right and left driven wheels 52.

In S106, the brake ECU 20 calculates the value of a time counter Cn. Specifically, the brake ECU 20 adds a predetermined value (e.g., 1) to the value of the previous time counter Cn−1 to calculate the value of the current time counter Cn.

In S108, the brake ECU 20 determines whether the predetermined condition is satisfied. Specifically, the brake ECU 20 determines that the predetermined condition is satisfied, when the vehicle body velocity Vx is larger than the first threshold value, the magnitude Vd of the difference between the rotational velocities Vr, Vl of the right and left driven wheels 52 is smaller than the second threshold value, and the time counter Cn is larger than a third value (e.g., a value equivalent to 15 minutes). When the brake ECU 20 determines that the predetermined condition is satisfied (YES in S108), the routine proceeds to S110.

In S110, the brake ECU 20 sets the expressway traveling flag Fj. For example, the brake ECU 20 sets the value of the expressway traveling flag Fj to a value indicating an ON state (e.g., 1).

In S112, the brake ECU 20 sets a value indicating the current time counter Cn as a value indicating the previous time counter Cn−1. The process is then ended. When the brake ECU 20 determines that the predetermined condition is not satisfied (NO in S108), the routine proceeds to S114.

In S114, the brake ECU 20 clears the expressway traveling flag Fj. For example, the brake ECU 20 sets the value of the expressway traveling flag Fj to a value indicating an OFF state (e.g., zero).

In S116, the brake ECU 20 resets the value indicating the current time counter Cn to an initial value (e.g., zero). The process is then ended.

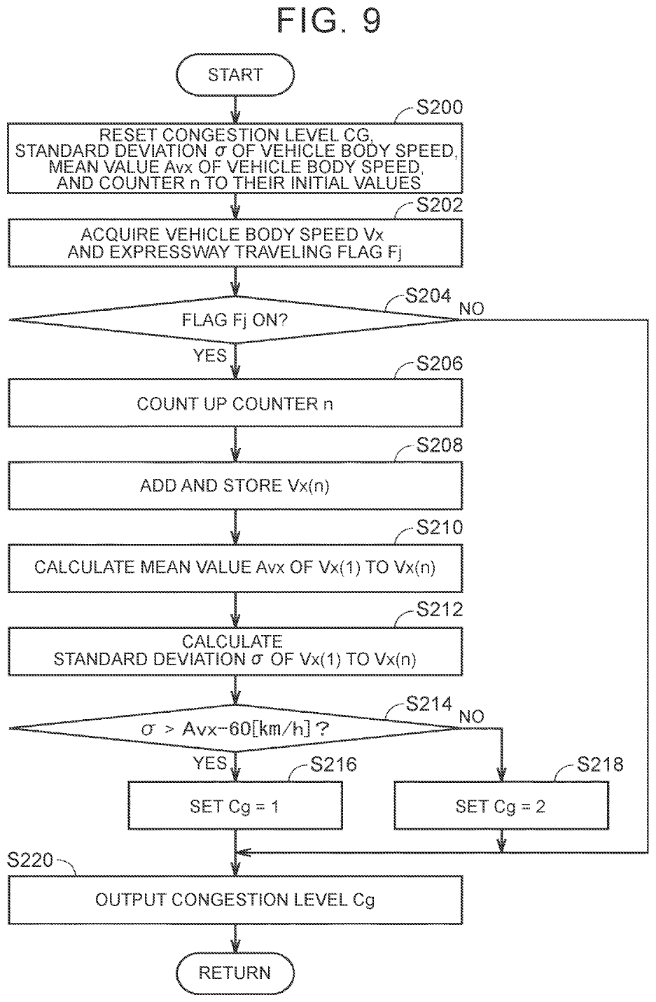

Next, an example of a process that is performed by the third processing unit 26 of the brake ECU 20 of the vehicle 2 will be described with reference to FIG. 9. FIG. 9 is a flowchart showing an example of a process that is performed by the third processing unit 26 of the brake ECU 20. A series of steps shown in this flowchart is repeatedly performed by the third processing unit 26 of the brake ECU 20 at predetermined control cycles. The third processing unit 26 performs the process shown in the flowchart of FIG. 9 when, for example, the vehicle 2 starts traveling or when the system of the vehicle 2 is started.

In 5200, the brake ECU 20 (specifically, the third processing unit 26) resets a value indicating the congestion level Cg, a value indicating the standard deviation σ of the vehicle body velocity Vx, a value indicating the mean value Avx of the vehicle body velocity Vx, and a value indicating a counter n to their initial values. Specifically, the brake ECU 20 sets each of these values to, for example, zero.

In S202, the brake ECU 20 acquires the vehicle body velocity Vx and the expressway traveling flag Fj. For example, the brake ECU 20 acquires the vehicle body velocity Vx calculated in the process shown FIG. 8 and the expressway traveling flag Fj.

In S204, the brake ECU 20 determines whether the expressway traveling flag Fj is ON. For example, the brake ECU 20 determines that the expressway traveling flag Fj is ON when the value indicating the expressway traveling flag Fj is 1. When the brake ECU 20 determines that the expressway traveling flag Fj is ON (YES in S204), the routine proceeds to S206. When the brake ECU 20 determines that the expressway traveling flag Fj is OFF (NO in S204), the routine proceeds to S220.

In S206, the brake ECU 20 counts up the counter n. Specifically, the brake ECU 20 adds a predetermined value (e.g., 1) to the previous value of the counter n to calculate a current value of the counter n.

In S208, the brake ECU 20 adds and stores the vehicle body velocity Vx acquired in S202 as a current value of Vx(n) to the vehicle body velocities Vx stored up to the previous value.

In S210, the brake ECU 20 calculates a mean value Avx of the vehicle body velocity Vx using n vehicle body velocities Vx, namely Vx(1) to Vx(n).

In S212, the brake ECU 20 calculates a standard deviation σ of the vehicle body velocity Vx using the n vehicle body velocities Vx, namely Vx(1) to Vx(n).

In S214, the brake ECU 20 determines whether the standard deviation σ is larger than the mean value Avx minus a predetermined value (e.g., 60 km/h in the present embodiment). When the brake ECU 20 determines that the standard deviation σ is larger than the mean value Avx minus 60 km/h (YES in S214), the routine proceeds to S216.

In S216, the brake ECU 20 sets the value of the congestion level Cg to 1 that is a value indicating that the expressway is congested. When the brake ECU 20 determines that the standard deviation σ is equal to or less than the mean value Avx minus 60 km/h (NO in S214), the routine proceeds to S218.

In S218, the brake ECU 20 sets the value of the congestion level Cg to 2 that is a value indicating that the expressway is not congested (traffic is flowing smoothly).

In S220, the brake ECU 20 outputs the value indicating the congestion level Cg to the central ECU 40. The central ECU 40 transmits the input information to the data center 100 via the DCM 30.

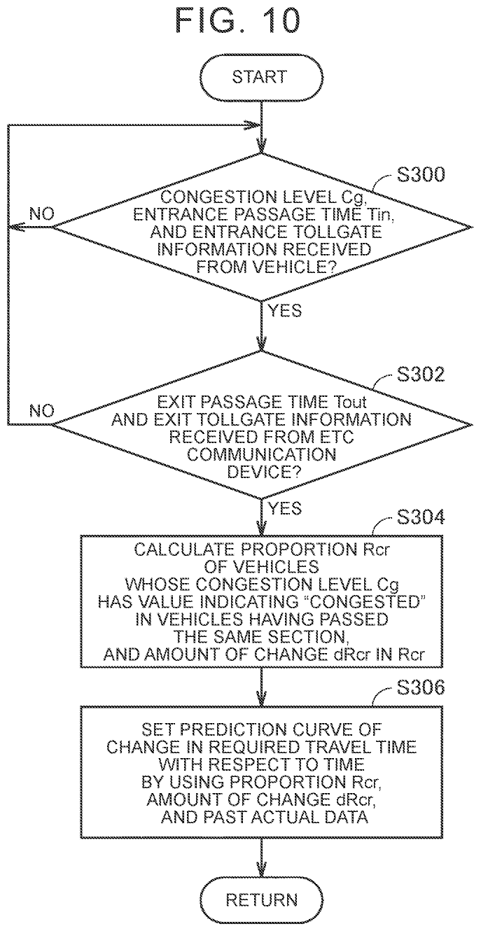

Next, an example of a process that is performed by the data center 100 will be described with reference to FIG. 10. FIG. 10 is a flowchart showing an example of a process that is performed by the data center 100. A series of steps shown in this flowchart is repeatedly performed by the data center 100 at predetermined control cycles.

In S300, the data center 100 determines whether the congestion level Cg, the entrance passage time Tin, and the entrance tollgate information have been received from a vehicle. For example, when the data center 100 receives information including the congestion level Cg and the entrance passage time Tin from a vehicle capable of communicating with the data center 100 such as the vehicle 2 or the vehicle 3, the data center 100 determines that the congestion level Cg and the entrance passage time Tin have been received from the vehicle. When the data center 100 determines that the congestion level Cg and the entrance passage time Tin have been received from the vehicle (YES in S300), the routine proceeds to S302.

In S302, the data center 100 determines whether the exit passage time Tout of the vehicle from which the congestion level Cg and the entrance passage time Tin had been received and the exit tollgate information have been received from the ETC communication device 110. When the data center 100 determines that the exit passage time Tout has been received (YES in S302), the routine proceeds to S304. When the data center 100 determines that the congestion level Cg and the entrance passage time Tin have not been received from the vehicle (NO in S300) or determines that the exit passage time Tout has not been received (NO in S302), the routine returns to S300.

In S304, the data center 100 calculates a proportion Rcr of vehicles whose congestion level Cg has a value (=1) indicating “congested” in a plurality of vehicles that has passed the same section as the vehicle from which the congestion level Cg and the entrance passage time Tin of the expressway have been received, and also calculates the amount of change dRcr in proportion Rcr per unit time.

In S306, the data center 100 sets a prediction curve of a change in required travel time with respect to time, based on the proportion Rcr, the amount of change dRcr, and actual data accumulated in the past. Since a method for setting a prediction curve is as described above, detailed description thereof will not be repeated.

The operation of the brake ECU 20, namely the vehicle information processing device according to the present embodiment, based on the above structure and flowcharts will be described.

For example, when the vehicle 2 starts traveling, the second processing unit 24 acquires the rotational velocities Vr, Vl of the right and left driven wheels 52 (S100), and calculates the vehicle body velocity Vx using the acquired rotational velocities Vr, Vl (S102). The second processing unit 24 then calculates the magnitude Vd of the difference between the rotational velocities Vr, Vl of the right and left driven wheels 52 (S104), counts up the time counter Cn (S106), and determines whether the predetermined condition is satisfied (S108).

When the state in which the vehicle body velocity Vx is higher than the first threshold value and the magnitude Vd of the difference between the rotational velocities Vr, Vl of the right and left driven wheels 52 is smaller than the second threshold value continues for more than the predetermined time, the second processing unit 24 sets the expressway traveling flag Fj (S110), and sets the value of the time counter Cn as the previous value (S112).

On the other hand, when the predetermined condition is not satisfied (NO in S108), the second processing unit 24 clears the expressway traveling flag Fj (S114) and resets the value of the time counter Cn to its initial value (S116).

When the vehicle 2 starts traveling, the third processing unit 26 resets the congestion level Cg, the standard deviation σ of the vehicle body velocity Vx, the mean value Avx of the vehicle body velocity Vx, and the counter n to their initial values (S200).

The third processing unit 26 acquires the vehicle body velocity Vx and the expressway traveling flag Fj from the second processing unit 24 (S202). When the expressway traveling flag Fj is ON (YES in S204), the third processing unit 26 counts up the counter n (S206), and adds and stores the acquired vehicle body velocity Vx as the vehicle body velocity Vx(n) corresponding to the counted-up counter n (S208). The third processing unit 26 then calculates a mean value Avx using the vehicle body velocities Vx(1) to Vx(n) (S210). The third processing unit 26 also calculates a standard deviation σ using the vehicle body velocities Vx(1) to Vx(n) (S212).

When the calculated standard deviation σ is larger than the mean value Avx minus 60 km/h (YES in S214), the third processing unit 26 sets the congestion level Cg is set to 1 that is a value indicating “congested” (S216), and outputs the congestion level Cg to the central ECU 40 (S220). The above process is repeated as long as the vehicle 2 continues to travel. The central ECU 40 acquires, for example, the entrance passage time Tin, namely the time the vehicle 2 passed an entrance of the expressway, from the ETC in-vehicle unit 32. The central ECU 40 transmits the congestion level Cg and the entrance passage time Tin to the data center 100 via the DCM 30.

The data center 100 receives the congestion level Cg and the entrance passage time Tin from the vehicle 2 (YES in S300). The congestion level Cg is generated every 15 minutes until the vehicle 2 passes through an exit of the expressway, and the generated congestion level Cg and the entrance passage time Tin are transmitted to the data center 100 via the central ECU 40 and the DCM 30.

When the vehicle 2 passes through an exit of the expressway, the data center 100 acquires the exit passage time Tout of the vehicle 2 from the ETC communication device 110 (YES in S302). Therefore, the data center 100 calculates the proportion Rcr and the amount of change dRcr using the congestion level Cg at the time the data center 100 received the exit passage time Tout, the entrance passage time Tin, and the exit passage time Tout (S304). By taking the calculated proportion Rcr and amount of change dRcr as input parameters, the data center 100 calculates the coefficient a using the first function f(Rcr, dRcr) and calculates the coefficient b using the second function g(Rcr, dRcr). The data center 100 thus identifies the point D in FIG. 7, and sets a prediction curve at and after the current time as shown by the dashed line in FIG. 7. The required travel time with respect to time can be predicted using the set prediction curve.

As described above, according to the vehicle information processing device of the present embodiment, the vehicle body velocity Vx of the vehicle 2 traveling on an expressway is calculated as a feature. Accordingly, the congestion level indicating the congestion state of the expressway can be accurately set by using a distribution of a plurality of features. The required travel time can therefore be accurately predicted according to the congestion state. A vehicle information processing device, prediction system, vehicle information processing method, and program that can accurately estimate the required travel time of a vehicle can thus be provided. In the present embodiment, the prediction system is composed of the vehicles 2, 3, the data center 100 that is an example of the “prediction device,” and the ETC communication device 110.

The predetermined condition includes the condition that the traveling state in which the vehicle body velocity Vx is larger than the first threshold value and the magnitude Vd of the difference between the rotational velocities Vr, Vl of the right and left driven wheels 52 is smaller than the second threshold value continues for the predetermined time or more. Whether the vehicle 2 is traveling on an expressway can thus be accurately determined using the rotational velocities Vr, Vl. Moreover, since the vehicle body velocity Vx is calculated using the rotational velocities of the driven wheels 52, the vehicle body velocity Vx can be more accurately calculated as compared to the case where the vehicle body velocity Vx is calculated using the rotational velocities of the drive wheels 50.

The congestion level indicating the congestion state of the expressway can be accurately set by, for example, calculating a standard deviation using a distribution of a plurality of features while the vehicle 2 is traveling on the expressway. Moreover, information that is valuable to users, such as the congestion state of the expressway, can be generated by performing, for example, concealment (e.g., statistic quantification) so that individuals cannot be identified.

Furthermore, since the vehicle 2 can transmit the information on the congestion level of the expressway to the outside of the vehicle 2 (data center 100), the utility value of the information on the congestion level of the expressway can be increased.

Moreover, since calculation of the feature and statistic quantification of the feature are separately performed by the second processing unit 24 and the third processing unit 26, only the statistic quantification process of the features that is performed by the third processing unit 26 can be changed and used to generate information on other change. This change of the statistic quantification process can be implemented by, for example, the brake ECU 20 reading the update information received from the data center 100 and stored in the memory of the central ECU 40.

Moreover, an accurate prediction curve can be set by receiving the congestion level Cg from a plurality of vehicles having passed the section from an entrance tollgate to an exit tollgate in which the vehicle 2 has passed.

Modifications will be described below. An example in which the input information input to the brake ECU 20 is subjected to the processes of the flowcharts of FIGS. 8 and 9 in the brake ECU 20 to perform calculation of the feature and statistic quantification of the feature is described in the above embodiment. However, these processes may be performed in the data center 100.

In the above embodiment, the data center 100 receives the congestion level Cg and the entrance passage time Tin from the vehicle 2 and receives the exit passage time Tout of the vehicle 2 from the ETC communication device 110. However, for example, the data center 100 may receive the congestion level Cg, the entrance passage time Tin, and the exit passage time Tout from the vehicle 2, or may receive the congestion level Cg, the entrance passage time Tin, and the exit passage time Tout of the vehicle 2 from the ETC communication device 110. The vehicle 2 may transmit the congestion level Cg and the entrance passage time Tin to the ETC communication device 110 via the second communication device 110b when passing through an exit of the expressway.

In the above embodiment, the operation of estimating the required travel time for the section from the entrance tollgate to the exit tollgate the vehicle 2 has passed is described as an example. However, the required travel time for a section from an entrance tollgate to an exit tollgate through which other vehicles pass can be similarly estimated. Therefore, by estimating the required travel times for sections of various combinations of an entrance tollgate and an exit tollgate as described above, an estimated value of the required travel time can be provided as requested by the user.

In the above embodiment, the congestion level Cg is set by using the standard deviation σ of the vehicle body velocity Vx that is a feature and the mean value Avx of the vehicle body velocity Vx. However, the congestion level Cg may be set by using a proportion of vehicles whose vehicle body velocity Vx that is a feature does not match a target velocity in cruise control in a plurality of vehicles under cruise control.

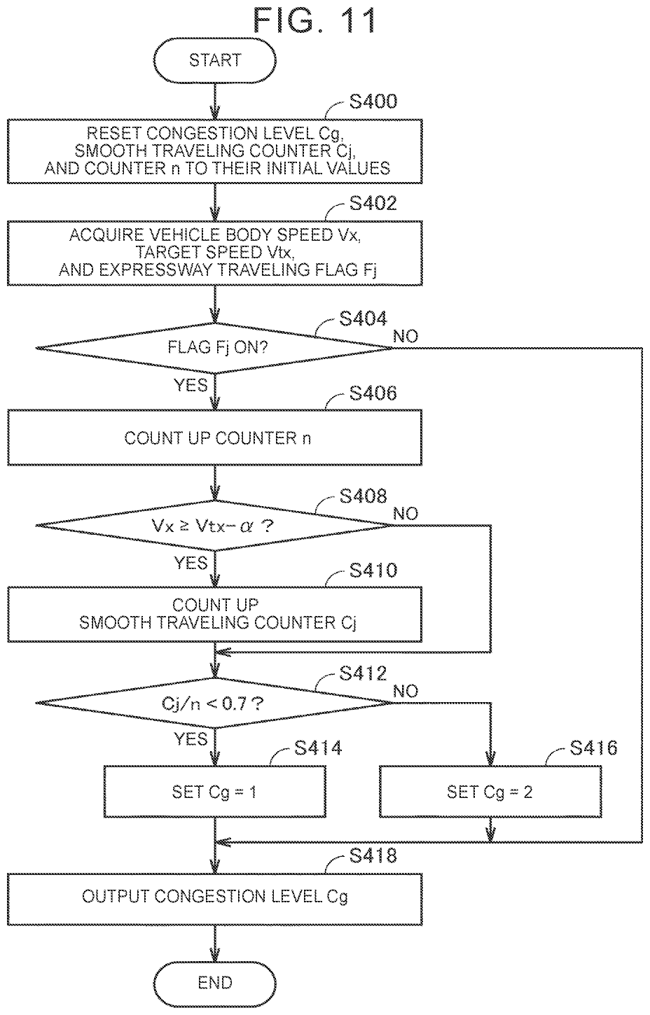

Next, an example of a process that is performed by the brake ECU 20 (specifically, the third processing unit 26) of the vehicle 2 in this modification will be described with reference to FIG. 11. FIG. 11 is a flowchart showing an example of a process that is performed by the third processing unit 26 of the brake ECU 20 in this modification.

In S400, the brake ECU 20 resets the value indicating the congestion level Cg, the value indicating a smooth traveling counter Cj, and the value indicating the counter n to their initial values (e.g., zero).

In S402, the brake ECU 20 acquires the vehicle body velocity Vx, a target velocity Vtx, and the expressway traveling flag Fj. The brake ECU 20 acquires, for example, the vehicle body velocity Vx calculated in the process shown in FIG. 8 and the expressway traveling flag Fj. The brake ECU 20 also acquires, for example, the target velocity Vtx in cruise control from the ADAS-ECU 10 having the driver assistance system such as the application that implements the functions of ACC.

In S404, the brake ECU 20 determines whether the expressway traveling flag Fj is ON. When the brake ECU 20 determines that the expressway traveling flag Fj is ON (YES in S404), the routine proceeds to S406. When the brake ECU 20 determines that the expressway traveling flag Fj is OFF (NO in S404), the routine proceeds to S418.

In S406, the brake ECU 20 counts up the counter n. Specifically, the brake ECU 20 adds a predetermined value (e.g., 1) to the previous value of the counter n to calculate a current value of the counter n.

In S408, the brake ECU 20 determines whether the vehicle body velocity Vx is equal to or larger than the target velocity Vtx minus a predetermined value α. The predetermined value α is, for example, a value for determining that the vehicle body velocity Vx is a velocity around the target velocity Vtx. For example, the predetermined value α may be a value determined in advance or may be set using the velocity limit, the number of lanes, etc. of the expressway. When the brake ECU 20 determines that the vehicle body velocity Vx is equal to or larger than the target velocity Vtx minus the predetermined value α (YES in S408), the routine proceeds to S410.

In S410, the brake ECU 20 counts up the smooth traveling counter Cj. Specifically, the brake ECU 20 adds a predetermined value (e.g., 1) to the previous value of the smooth traveling counter Cj to calculate a current value of the smooth traveling counter Cj.

In S412, the brake ECU 20 determines whether the smooth traveling counter Cj divided by the counter n is smaller than a third threshold value (e.g., 0.7). The third threshold value is a threshold value for determining whether the expressway on which the vehicle 2 travels is congested. For example, the third threshold value may be a value determined in advance or may be set using the velocity limit, the number of lanes, etc. of the expressway. When the brake ECU 20 determines that the smooth traveling counter Cj divided by the counter n is smaller than the third threshold value (YES in S412), the routine proceeds to S414.

In S414, the brake ECU 20 sets the value of the congestion level Cg to 1 that is a value indicating that the expressway is congested. When the brake ECU 20 determines that the smooth traveling counter Cj divided by the counter n is equal to or larger than the third threshold value (NO in S412), the routine proceeds to S416.

In S416, the brake ECU 20 sets the value of the congestion level Cg to 2 that is a value indicating that the expressway is not congested (traffic is flowing smoothly).

In S418, the brake ECU 20 outputs the value indicating the congestion level Cg to the central ECU 40. The central ECU 40 transmits the input information to the data center 100 via the DCM 30.

The operation of the brake ECU 20, namely the vehicle information processing device in this modification, based on the above structure and flowchart will be described. Since the operation of the second processing unit 24 is as described above, detailed description thereof will not be repeated.

When the vehicle 2 starts traveling, the third processing unit 26 resets the congestion level Cg, the smooth traveling counter Cj, and the counter n to their initial values (S400).

The third processing unit 26 acquires the vehicle body velocity Vx, the target velocity Vtx, and the expressway traveling flag Fj from the second processing unit 24 (S402). When the expressway traveling flag Fj is ON (YES in S404), the third processing unit 26 counts up the counter n (S406). When the acquired vehicle body velocity Vx is equal to or larger than the target velocity Vtx minus the predetermined value α, the third processing unit 26 counts up the smooth traveling counter Cj. When such a state continues, the smooth traveling counter Cj divided by the counter n becomes equal to or larger than 0.7 (NO in S412). Therefore, the third processing unit 26 sets the congestion level Cg to 2 that is a value indicating an uncongested state.

On the other hand, when the expressway becomes congested and the vehicle body velocity Vx becomes lower than the target velocity Vtx minus the predetermined value α (NO in S408), the third processing unit 26 counts up the counter n but does not count up the smooth traveling counter Cj. Therefore, the smooth traveling counter Cj divided by the counter n will decrease. When such a state continues and the smooth traveling counter Cj divided by the counter n becomes smaller than 0.7 (YES in S412), the third processing unit 26 sets the congestion level Cg to 1 that is a value indicating a congested state (S414). The third processing unit 26 outputs the set congestion level Cg to the central ECU 40 (S418). The above process is repeated as long as the vehicle 2 continues to travel. The central ECU 40 transmits the congestion level Cg and the entrance passage time Tin to the data center 100 via the DCM 30. Since the operation of the data center 100 is as described above, detailed description thereof will not be repeated.

As described above, according to the vehicle information processing device of the modification, the congestion state of an expressway can be accurately estimated using the rate at which the vehicle body velocity Vx achieves the target velocity Vtx. The required travel time can therefore be accurately predicted according to the congestion state.

A part or all of the above modifications may be combined as appropriate. The embodiment disclosed herein should be construed as illustrative, not restrictive, in all respects. The scope of the present disclosure is shown by the claims rather than by the above description and is intended to include all modifications within the meaning and scope equivalent to the claims.

What is claimed is:

1. A vehicle information processing system comprising a vehicle information processing device including one or more processors configured to:
receive input information including information on a wheel velocity of a vehicle; and
calculate a velocity of the vehicle traveling on an expressway as a feature by using the input information, wherein
the input information is information that is received during a period in which a predetermined condition is satisfied out of a period in which the one or more processors receive the input information, and
the predetermined condition indicates that the vehicle is traveling on the expressway.

2. The vehicle information processing system according to claim 1, wherein
the input information includes information on wheel velocities of right and left wheels of the vehicle, and
the predetermined condition includes a condition that a traveling state continues for a predetermined time or more, and
the traveling state is a state in which the velocity of the vehicle is higher than a first threshold value and a magnitude of a difference between the wheel velocities of the right and left wheels is smaller than a second threshold value.

3. The vehicle information processing system according to claim 1, wherein the one or more processors are configured to generate a congestion level indicating a degree of congestion of the expressway by using a distribution of a plurality of the features calculated during the period in which the predetermined condition is satisfied.

4. The vehicle information processing system according to claim 3, wherein the one or more processors are configured to:
calculate a standard deviation of the velocity of the vehicle calculated a plurality of times during the period in which the predetermined condition is satisfied; and
set the congestion level to a value indicating that the expressway is congested, when the standard deviation is larger than a threshold value.

5. The vehicle information processing system according to claim 3, wherein
the one or more processors are configured to set the congestion level to a value indicating that the expressway is congested, when a rate is smaller than a threshold value during the period in which the predetermined condition is satisfied, and
the rate is a rate at which the velocity of the vehicle under cruise control achieves a target velocity set in the cruise control.

6. The vehicle information processing system according to claim 3, wherein the one or more processors are configured to transmit information on the congestion level to outside of the vehicle.

7. The vehicle information processing system according to claim 1 further comprising a prediction device, the prediction device configured to:
predict a required travel time in a predetermined section in which the vehicle travels on the expressway by using information from a plurality of the vehicles equipped with the vehicle information processing device; and
predict the required travel time from a proportion of the vehicles with a predetermined congestion level in the vehicles.

8. A vehicle information processing method, comprising:
receiving input information including information on a wheel velocity of a vehicle; and
calculating a velocity of the vehicle traveling on an expressway as a feature by using the input information, wherein
the input information is information that is received during a period in which a predetermined condition is satisfied out of a period in which the input information is received, and
the predetermined condition indicates that the vehicle is traveling on the expressway.

9. A non-transitory storage medium storing instructions that are executable by one or more processors in a computer and that cause the one or more processors to perform functions comprising:
receiving input information including information on a wheel velocity of a vehicle; and
calculating a velocity of the vehicle traveling on an expressway as a feature by using the input information, wherein
the input information is information that is received during a period in which a predetermined condition is satisfied out of a period in which the input information is received, and
the predetermined condition indicates that the vehicle is traveling on the expressway.
